(19) United States
(12) Patent Application Publication
(10) Pub. No.: US 2004/0074335 A1
(43) Pub. Date: Apr. 22, 2004

(54) Powder metal connecting rod

(75) Inventor: Warren J. Whitney, Ypsilanti, MI (US)

Correspondence Address: Robert L. Stearns, 5291 Colony Drive North, Saginaw, MI, 48603, US

(73) Assignee: FEDERAL-MOGUL WORLD WIDE, INC.

(21) Appl. No.: 10/277,785

(22) Filed: Oct. 22, 2002

(51) Int. Cl. G05G 1/00

(52) U.S. Cl. 74/579 R

(57) ABSTRACT

A connecting rod for an internal combustion engine comprises a non-ferrous powder metal material body of a first composition. The body has a small end opening and a large end opening. A bearing surface portion surrounds the large end opening and is fabricated of a non-ferrous powder metal material of a second composition different than the first non-ferrous composition. The first and second compositions are compacted and sintered together with the second material of the bearing surface portion surrounding and being localized about the large and opening.

### BACKGROUND OF THE INVENTION

1. Field of the Invention

The invention relates generally to powder metal connecting rods, and more particularly to the formation bearing surfaces of the connecting rods.

2. Related Art

Connecting rods are typically forged of ferrous material with opposite ends constructed for attachment to a wrist pin of a piston assembly and a crank of a crank shaft. It is also known to make the connecting rods from ferrous powder metal. The end connected to the crank is the larger of the two ends and typically has a separately formed bearing inserted within a bore of the end to journal the crank. The bearings are typically split half shell type bearings having an arcuate steel backing on which a layer or layers of non-ferrous bearing material are applied, such as aluminum or copper-based alloys, to provide a low friction running surface for the crank of the connecting rod.

Forming the bearings separately from the commuting rod adds cost and complexity to the manufacture of connecting rods.

### SUMMARY OF THE INVENTION

A powder metal connecting rod for an internal combustion engine comprises a connecting rod body fabricated of a non-ferrous powder metal material of a first composition. The body has a small end opening for connection to a wrist pin and a large end opening for connection to a crank shaft. A bearing surface portion of the connecting rod surrounds at least the large end opening and is fabricated of a non-ferrous powder metal material of a second composition different from the first composition and compacted and sintered together as one unitized structure with the connecting rod body.

According to another aspect of the invention, a method is provided for making a connecting rod having at least one end opening. The method includes providing a first composition of non-ferrous powder metal material and a second composition of non-ferrous powder metal material different from the first composition. The first and second compositions are compacted and sintered together. The second material is localized and forms a bearing surface portion surrounding the at least one end opening.

The invention has the advantage of providing a simple process for making non-ferrous powder metal connecting rods.

Another advantage of the present invention is that the connecting rod is formed with an integral bearing that is fabricated of powder metal which is metallurgically united with the body of the connecting rod during the compaction and sintering of the body. This has the further advantage of simplifying the manufacture and construction of connecting rods.

Unitizing the bearing portion has the advantage of eliminating the need to separately make and install the bearing in the rod and for providing high clamping loads normally required to support conventional half bearings in place in a large end of a connecting rod.

### BRIEF DESCRIPTION OF THE DRAWINGS

These and other features and advantages of the present invention will become more readily appreciated when considered in connection with the following detailed description and appended drawings, wherein:

FIG. 1 is a plan view of a connecting rod constructed according to a presently preferred embodiment of the invention;

FIG. 2 is an enlarged fragmentary sectional view of the connecting rod; and

FIG. 3 is a cross-sectional view along a parting plane of the connecting rod.

### DETAILED DESCRIPTION OF THE PREFERRED EMBODIMENTS

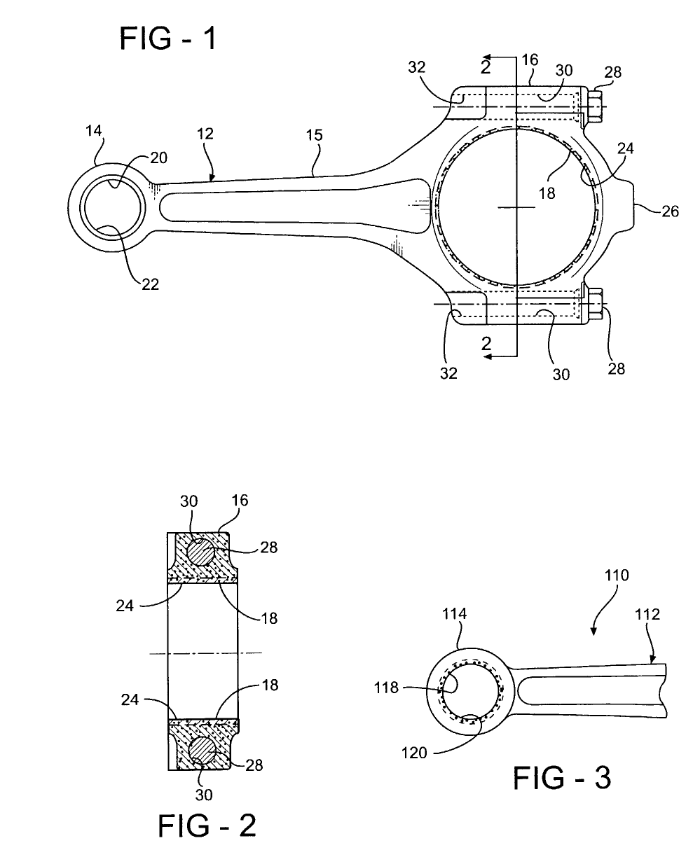

A connecting rod constructed according to a presently preferred embodiment of the invention is shown generally at 10 in FIG. 1. The connecting rod 10 has a body 12 with a small end 14 and a large end 16 and a rod portion 15 therebetween. A bearing surface portion 18 is formed within the large end 16 to reduce friction between a crank shaft (not shown) and the large end 16 of the connecting rod 10. The body 12 of the connecting rod 10 is formed from a first non-ferrous powder metal material composition, while the bearing surface portion 18 is formed from a second non-ferrous powder metal material composition different from the first composition. The first and second powder metal material compositions are compacted and sintered together to form the connecting rod 10.

The small end 14 of the connecting rod 10 has an opening 20. As shown in FIG. 1, a bushing 22 is preferably inserted in the opening 20. The bushing 22 is constructed from any suitable bearing material and provides journaled support to a wrist pin (not shown) of a piston (not shown) in known manner.

The large end 16 has an opening 24 about which the bearing surface portion 18 is formed. The large end 16 is preferably split at parting plane 25 to define a separable bearing cap 26 that is removably fastened to the remaining portion of the connecting rod 10 in known manner by a pair of fasteners 28 or the like. The bearing cap 26 preferably has a pair of openings 30 for receiving the fasteners 28, while the other half of the large end 16 preferably has a pair of threaded openings 32 for threadedly engaging the fasteners 28, in known manner.

The first and second compositions are preferably chosen to be metallurgically compatible with one another such that the materials can be compacted and sintered together as one structure. The first and second compositons are preferably aluminum-based alloy powders, but the invention contemplates other non-ferrous, metallurgically compatible compositions as well, such as magnesium-based alloys, for example. The first composition, which may comprise an aluminum-based powder metal alloy material preferably containing silicon carbides, creates a metal matrix composite and forms a substantial portion or majority of the body 12. The metal matrix composite provides excellent compressive and tensile strength properties to the connecting rod 10. The second composition may comprise any of a number of aluminum-based powder metal alloy materials which are suitable for bearing applications.

The first and second compositions are compacted together in an unsintered or “green state” to provide a powder metal preform having the general shape of the connecting rod 10. With the first composition forming the substantial portion of the body 12, and the second composition being localized around the large opening 24 and forming the bearing surface portion 18 the compacted connecting rod preform is sintered.

The sintering process is performed by heating and holding the first and second compacted compositions at a common sintering temperature for a predetermined time. It is understood that the term “sintering temperature” means the temperature at which the materials are sintered during a sintering cycle, and that the actual temperature value may vary during the cycle, but the materials nonetheless are maintained at a common temperature relative to one another during the sintering cycle. Upon sintering the connecting rod 10, the large end 16 of the connecting rod 10 can be machined so that the openings 30 and the threaded openings 32 are formed on opposite sides of the large end 16. Upon forming the openings 30, 32, the bearing cap 26 is preferably split from the remaining portion of the connecting rod 10 by known cutting or fracturing processes.

As shown best in FIG. 2, the bearing surface 18 portion is formed as one united structure with the body 12. The bearing surface portion 18 surrounds and lines the opening 24 and extends radially outwardly of the opening 24 where it is metallurgically bonded or united with the first material of the body 12 at an interface schematically represented by broken chain line 33 in FIG. 2. At the interface 33, the first and second materials are sintered together to diffuse the materials across the interface 33. This produces a permanent, inseparable bond that unites the materials as one integral structure, while maintaining a distinct concentrated region of the second material around the opening 24 to define the bearing surface portion 18. Since the first composition is preferably an aluminum-based material, it advantageously provides an emergency wear surface in the event that the bearing surface 18 becomes damaged.

As best shown in FIG. 3, an alternate embodiment of a presently preferred construction of a connecting rod is shown generally at 110. The connecting rod 110 has a body 112 with a small end 114. The small end 114 can be constructed similarly as the large end 16 in the previous embodiment. Therefore, instead of having a bushing 22 inserted within the opening 20, as in the previous embodiment, a bearing surface portion 118 can be formed within an opening 120 of the small end 114 preferably using the second powder metal composition as used in the opening 24 of the large end 16. Otherwise, it should be recognized that the construction of the connecting rod 110 is substantially identical to that of the connecting rod 10 in the previous embodiment.

Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. A powder metal connecting rod for an internal combustion engine, comprising:
a connecting rod body fabricated of compacted and sintered non-ferrous powder metal material of a first composition having a small end opening for connection to a wrist pin and a large end opening for connection to crank shaft; and
a bearing surface portion of the connecting rod body surrounding at least said large end opening and fabricated of a non-ferrous powder metal material of a second composition different from said first composition and compacted and sintered as one unitized structure with said connecting rod body.

2. The connecting rod of claim 1 wherein said first and second composition are each aluminum-based alloy compositions.

3. The connecting rod of claim 2 wherein said second composition comprises a bearing metal alloy.

4. The connecting rod of claim 1 wherein said connecting rod body is split at said large end opening.

5. A method of making a connecting rod having at least an end opening, comprising:
providing a non-ferrous powder metal material of a first composition;
providing a non-ferrous powder metal material of a second composition different from the first composition; and
placing the first and second powder metal materials in a mold with the first material constituting the majority of the connecting rod material and the second material being localized around the at least one end opening and compacting and sintering the first and second compositions together forming a body of the connecting rod of the first powder metal material and a bearing surface portion surrounding the at least one end opening of the second material.

6. The method of claim 5 including selecting the first and second powder metal compositions from aluminum-based alloy compositions.

7. The method of claim 5 wherein the first and second compositions are sintered at the same temperature.

8. The method of claim 5 wherein the second material is located around a large end opening of the connecting rod.

9. The method of claim 8 including splitting the connecting rod at the large end opening.
